(19) United States
(12) Patent Application Publication
(10) Pub. No.: US 2024/0298578 A1
(43) Pub. Date: Sep. 12, 2024

(54) SYSTEM AND METHOD FOR AGRICULTURAL VEHICLE

(71) Applicant: CNH Industrial Brasil Ltda., Nova Lima (BR)

(72) Inventors: ANDRÉ LUÍS PAVAN, Piracicaba-SP (BR); JOÃO AUGUSTO MARCOLIN LUCCA, Piracicaba-SP (BR); LEONARDO DOS SANTOS CARVALHO, Piracicaba-SP (BR)

(21) Appl. No.: 18/599,367

(22) Filed: Mar. 8, 2024

(30) Foreign Application Priority Data
Mar. 8, 2023 (BR) 10 2023 004338 0

(51) Int. Cl. A01D 90/10; A01D 45/10

(52) U.S. Cl. CPC A01D 90/10; A01D 45/10

(57) ABSTRACT

A system for an agricultural vehicle includes an elevator assembly defining an elevator discharge opening. A first display is positioned at least partially on a first side of a vehicle centerline of the agricultural vehicle. A second display is positioned at least partially on a second side of a vehicle centerline of the agricultural vehicle. A computing system is communicatively coupled to the first display and the second display. The computing system is configured to determine a position of the elevator discharge opening relative to the vehicle centerline, display a first set of information on the first display when the elevator discharge opening is positioned on the first side of the vehicle centerline, and display the first set of information on the second display when the elevator discharge opening is positioned on the second side of the vehicle centerline.

### CROSS-REFERENCE TO RELATED APPLICATION

The present application claims priority to BR Patent Application Serial No. BR 10 2023 004338 0, filed on Mar. 8, 2023, the contents of which are hereby incorporated by reference in their entirety.

### FIELD

The present disclosure generally relates to a system and method for providing information to a user of a work vehicle, such as an agricultural harvester.

### BACKGROUND

Several models of agricultural vehicles and equipment are developed to increase productivity in the harvesting of numerous types of crops. For example, some agricultural vehicles may be configured for use with so-called tall and stalky crops, such as sugarcane and sweet sorghum. The vehicles particularly intended for the harvesting of tall and stalky plants are designed and developed to promote the harvesting of this specific type of crop because their intrinsic characteristics can require proper conditions for the adequate processing thereof, from cutting to transfer to transshipments and/or trucks.

The vehicles intended for the harvesting the tall and stalky crops include a chassis designed to support a series of components responsible for cutting, harvesting, conducting, and chopping the cane and/or sorghum into billets, which are then transferred to the transshipments and/or cane and/or sorghum trucks through an elevator assembly. Furthermore, this type of agricultural vehicle has a cutting and harvesting assembly that comprises a number of components, such as line dividers, knock-down rollers, base cutting discs, and lift rollers.

In some instances, information related to the vehicle and/or one or more of the processes performed by the harvester may be provided to an operator or user of the vehicle. In some cases, an improved system for providing information would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for an agricultural harvester. The system includes an elevator assembly defining an elevator discharge opening. A first display is positioned at least partially on a first side of a vehicle centerline of the agricultural vehicle. A second display is positioned at least partially on a second side of a vehicle centerline of the agricultural vehicle. A computing system is communicatively coupled to the first display and the second display. The computing system is configured to determine a position of the elevator discharge opening relative to the vehicle centerline, display a first set of information on the first display when the elevator discharge opening is positioned on the first side of the vehicle centerline, and display the first set of information on the second display when the elevator discharge opening is positioned on the second side of the vehicle centerline.

In some aspects, the present subject matter is directed to a method for operating an agricultural vehicle. The method includes determining a position of an elevator discharge opening relative to a vehicle centerline. The method also includes providing a first set of information on a first display positioned at least partially on a first side of the vehicle centerline and a second set of information on a second display positioned at least partially on a second side of the vehicle centerline when the elevator discharge opening is positioned on the first side of the vehicle centerline. Lastly, the method includes providing the first set of information on the second display and the second set of information on the first display when the elevator discharge opening is positioned on the second side of the vehicle centerline.

In some aspects, the present subject matter is directed to a system for an agricultural vehicle. The system includes an elevator assembly defining an elevator discharge opening. A first display is positioned at least partially on a first side of a vehicle centerline of the agricultural vehicle. A computing system is communicatively coupled to the first display. The computing system is configured to determine a position of the elevator discharge opening relative to the vehicle centerline, provide a first set of information on the first side of the vehicle centerline when the elevator discharge opening is positioned on the first side of the vehicle centerline, and provide the first set of information on the second side of the vehicle centerline when the elevator discharge opening is positioned on a second side of the vehicle centerline.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic side view of an agricultural vehicle for the harvesting of tall and stalky vegetable crops, such as sugarcane and sorghum, in accordance with aspects of the present subject matter;

FIG. 2 is a top perspective view of a cab of the agricultural vehicle in accordance with aspects of the present subject matter;

FIG. 3 is a top perspective view of a cab of the agricultural vehicle in accordance with aspects of the present subject matter;

FIG. 4 is a top perspective view of a cab of the agricultural vehicle in accordance with aspects of the present subject matter;

FIG. 5 illustrates a block diagram of components of a system for the agricultural vehicle in accordance with aspects of the present subject matter;

FIG. 6 is a top perspective view of the agricultural vehicle within a field in accordance with aspects of the present subject matter;

FIG. 7 is a top perspective view of a cab of the agricultural vehicle in accordance with aspects of the present subject matter;

FIGS. 8 and 9 illustrate first and second displays operably coupled with the agricultural vehicle in accordance with aspects of the present subject matter;

FIG. 10 is a top perspective view of the agricultural vehicle within a field in accordance with aspects of the present subject matter;

FIG. 11 is a top perspective view of a cab of the agricultural vehicle in accordance with aspects of the present subject matter;

FIGS. 12 and 13 illustrate first and second displays operably coupled with the agricultural vehicle in accordance with aspects of the present subject matter; and

FIG. 14 illustrates a flow diagram of a method for operating an agricultural vehicle in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided from way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product through a system. For example, “upstream” refers to the direction from which an agricultural product moves, and “downstream” refers to the direction to which the agricultural product moves. The term “selectively” refers to a component's ability to operate in various states (e.g., an ON state and an OFF state) based on manual and/or automatic control of the component.

The terms “fore” and “aft” refer to relative positions along the agricultural vehicle relative to a fore-aft axis. The fore direction is a direction along the fore-aft axis that may also be referred to as a forward motion direction of the vehicle. In addition, an aft direction along the fore-aft is a direction along the fore-aft axis that may also be referred to as a rearward motion direction of the vehicle. A lateral direction may be defined by a transverse axis that extends between a right side and a left side of the vehicle and may be perpendicular to the fore-aft axis. As such, any component that is “laterally inward” of another component may be positioned in closer proximity to the fore-aft axis and any component that is “laterally outward” of another component may be positioned in closer proximity to the fore-aft axis along the transverse axis. A longitudinal direction may be defined as a third direction in a three-dimensional plane that is perpendicular to the fore-aft axis and the transverse axis. For example, the height of the vehicle may be defined in the longitudinal direction.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to an agricultural harvester that can include an elevator assembly defining an elevator discharge opening. The harvester can also include a first display positioned at least partially on a first side of a vehicle centerline of the agricultural vehicle and a second display positioned at least partially on a second side of a vehicle centerline of the agricultural vehicle. Each of the first display and the second display may be configured to provide information to the operator. For instance, one of the first display and the second display may provide a first set of information related to operational information while the other one or the first display and second display may provide a second set of information related to vehicle information. In some cases, the first display may provide the first set of information and the second display may provide the second set of information when an elevator discharge opening is positioned on a first common side of the vehicle centerline. Conversely, the second display may provide the first set of information and the second display may provide the first set of information when the elevator discharge opening is positioned on a second common side of the vehicle centerline. As such, a focus region that includes a line of sight to the elevator discharge opening, the operational information, and the vehicle centerline may also be located on a common side of the vehicle centerline as the elevator discharge opening.

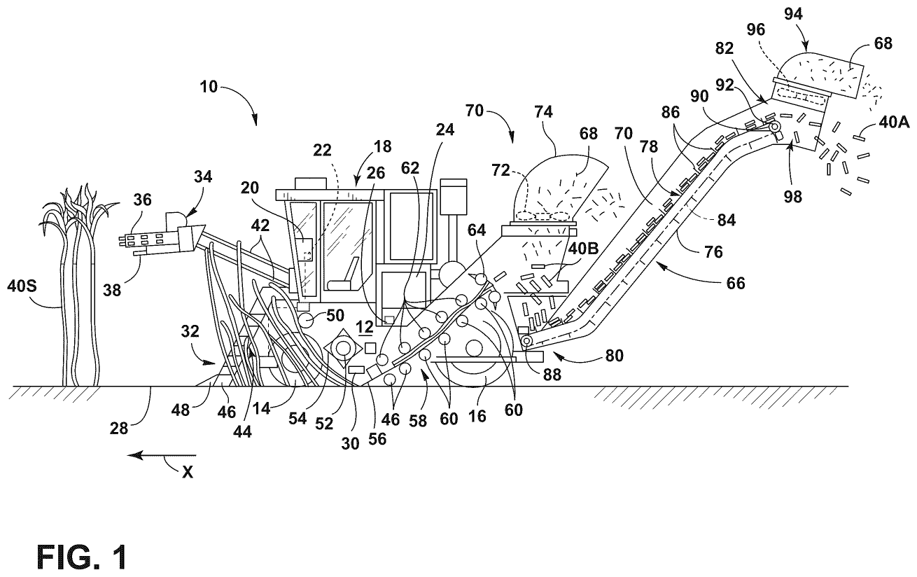

Referring now to the drawings, FIG. 1 illustrates a side view of an agricultural vehicle 10 in accordance with aspects of the present subject matter. As shown, the vehicle 10 is configured as a sugarcane harvester. However, in other embodiments, the vehicle 10 may correspond to any other suitable agricultural harvester or work vehicle.

As shown in FIG. 1, the vehicle 10 can include a frame 12, a pair of front wheels 14, a pair of rear wheels 16, and an operator's cab 18 or any other form of operator's station, for permitting the operator to control the operation of the vehicle 10. As illustrated in the example shown in FIG. 1, the vehicle 10 may include a human-machine interface (HMI) 20 for displaying information (e.g., messages and/or alerts) to the operator and/or for allowing the operator to interface with various systems and components of the vehicle 10.

The HMI 20 may also receive a user input, through one or more input devices 22 (e.g., levers, pedals, control panels, buttons, and/or the like) within the cab 18 and/or in any other practicable location. In some cases, the HMI 20 can include a pair of displays and the information provided on each display may be altered based on various vehicle conditions. The information provided may include operational information that may impact harvesting performance, which may be presented on a clear interface with minimal visual pollution for the operator or another individual. Additionally or alternatively, the HMI 20 may provide support information that can include a vehicle information, such as vehicle status, vehicle maintenance, and/or the like that may be intermittently monitored by the operator or another individual.

The vehicle 10 may also include a power source 24 (e.g., an engine mounted on the frame 12) that powers one or both pairs of the wheels 14, 16 via a driveline assembly 26 (e.g., a transmission) to traverse a field 28. Alternatively, the vehicle 10 may be a track-driven vehicle and, thus, may include tracks driven by the power source 24 as opposed to the illustrated wheels 14, 16. The power source 24 may also drive a hydraulic fluid pump 30 configured to generate pressurized hydraulic fluid for a hydraulic circuit, which may be configured to power various components of the vehicle 10, including the driveline assembly 26.

The vehicle 10 may also include a crop processing system 32 incorporating various components, assemblies, and/or sub-assemblies of the vehicle 10 for cutting, processing, cleaning, and discharging sugarcane as the cane is harvested from an agricultural field 28. For instance, the crop processing system 32 may include a topper assembly 34 positioned at the front end portion of the vehicle 10 to intercept sugarcane as the vehicle 10 is moved in a forward direction. As shown, the topper assembly 34 may include both a gathering disk 36 and a cutting disk 38. The gathering disk 36 may be configured to gather the sugarcane stalks 40S so that the cutting disk 38 may be used to cut off the top of each stalk 40S. As is generally understood, the height of the topper assembly 34 may be adjustable via a pair of arms 42, which may be hydraulically raised and lowered.

The crop processing system 32 may further include a crop divider 44 that extends upwardly and rearwardly from the field 28. In general, the crop divider 44 may include one or more spiral feed rollers 46. Each feed roller 40 may include a ground shoe 48 at its lower end portion to assist the crop divider 44 in gathering the sugarcane stalks 40S for harvesting. Moreover, as shown in FIG. 1, the crop processing system 32 may include a knock-down roller 50 positioned near the front wheels 14 and a fin roller 52 positioned behind the knock-down roller 50. As the knock-down roller 50 is rotated, the sugarcane stalks 40S being harvested are knocked down while the crop divider 44 gathers the stalks 40S from agricultural field 28. Further, as shown in FIG. 1, the fin roller 52 may include a plurality of intermittently mounted fins 54 that assist in forcing the sugarcane stalks 40S downwardly. As the fin roller 52 is rotated during the harvest, the sugarcane stalks 40S that have been knocked down by the knock-down roller 50 are separated and further knocked down by the fin roller 52 as the vehicle 10 continues to be moved in the forward direction relative to the field 28.

Referring still to FIG. 1, the crop processing system 32 of the vehicle 10 may also include a base cutter assembly 56 positioned behind the fin roller 52. The base cutter assembly 56 may include blades for severing the sugarcane stalks 40S as the cane is being harvested. Additionally, in several embodiments, the blades may be angled downwardly to sever the base of the sugarcane as the cane is knocked down by the fin roller 52.

Moreover, the crop processing system 32 may include a feed roller assembly 58 located downstream of the base cutter assembly 56 for moving the severed stalks 40S of sugarcane from base cutter assembly 56 along the processing path of the crop processing system 32. As shown in FIG. 1, the feed roller assembly 58 may include a plurality of bottom rollers 60 and a plurality of opposed, top rollers 62. The various bottom and top rollers 60, 62 may be used to pinch the harvested sugarcane during transport. As the sugarcane is transported through the feed roller assembly 58, debris (e.g., rocks, dirt, and/or the like) may be allowed to fall through bottom rollers 60 onto the field 28.

In addition, the crop processing system 32 may include a chopper assembly 64 located at the downstream end section of the feed roller assembly 58 (e.g., adjacent to the rearward-most bottom roller 60 and the rearward-most top roller 62). In general, the chopper assembly 64 may be used to cut or chop the severed sugarcane stalks 40S into pieces or “billets” 40B, which may be, for example, six (6) inches long. The billets 40B may then be propelled towards an elevator assembly 66 of the crop processing system 32 for delivery to an external receiver or storage device.

The pieces of debris 68 (e.g., dust, dirt, leaves, etc.) separated from the sugarcane billets 40B may be expelled from the vehicle 10 through a primary extractor 70 of the crop processing system 32, which may be located downstream of the chopper assembly 64 and may be oriented to direct the debris 68 outwardly from the vehicle 10. Additionally, an extractor fan 72 may be mounted within an extractor housing 74 of the primary extractor 70 for generating a suction force or vacuum sufficient to force the debris 68 through the primary extractor 70. The separated or cleaned billets 40B, which may be heavier than the debris 68 expelled through the extractor 70, may then fall downward to the elevator assembly 66.

As shown in FIG. 1, the elevator assembly 66 may include an elevator housing 76 and an elevator 78 extending within the elevator housing 76 between a lower, proximal end portion 80 and an upper, distal end portion 82. In some examples, the elevator 78 may include a looped chain 84 and a plurality of flights or paddles 86 attached to and spaced on the chain 84. The paddles 86 may be configured to hold the sugarcane billets 40B on the elevator 78 as the sugarcane billets 40B are elevated along a top span of the elevator 78 defined between its proximal and distal end portions 80, 82. Additionally, the elevator 78 may include lower and upper sprockets 88, 90 positioned at its proximal and distal end portions 80, 82, respectively. As shown in FIG. 1, an elevator motor 92 may be coupled to one of the sprockets (e.g., the upper sprocket 90) for driving the chain 84, thereby allowing the chain 84 and the paddles 86 to travel in a loop between the proximal and distal ends 80, 82 of the elevator 78.

Moreover, in some embodiments, pieces of debris 68 (e.g., dust, dirt, leaves, etc.) separated from the elevated sugarcane billets 40B may be expelled from the vehicle 10 through a secondary extractor 94 of the crop processing system 32 coupled to the rear end portion of the elevator housing 76. For example, the debris 68 expelled by the secondary extractor 94 may be debris 68 remaining after the billets 40B are cleaned and debris 68 expelled by the primary extractor 70. As shown in FIG. 1, the secondary extractor 94 may be located adjacent to the distal end portion 82 of the elevator 78 and may be oriented to direct the debris 68 outwardly from the vehicle 10. Additionally, an extractor fan 96 may be mounted at the base of the secondary extractor 94 for generating a suction force or vacuum sufficient to force the debris 68 through the secondary extractor 94. The separated, cleaned billets 40B, heavier than the debris 68 expelled through the primary extractor 70, may then fall from the distal end portion 82 of the elevator 78. In some instances, the billets 40B may fall through an elevator discharge opening 98 defined by the elevator assembly 66 into an external storage device, such as a sugarcane billet cart.

During operation, the vehicle 10 traverses the agricultural field 28 for harvesting sugarcane. After the height of the topper assembly 34 is adjusted via the arms 42, the gathering disk 36 on the topper assembly 34 may function to gather the sugarcane stalks 40S as the vehicle 10 proceeds across the field 28, while the cutting disk 38 severs the leafy tops of the sugarcane stalks 40S for disposal along either side of vehicle 10. As the stalks 40S enter the crop divider 44, the ground shoes 48 may set the operating width to determine the quantity of sugarcane entering the throat of the vehicle 10. The spiral feed rollers 46 then gather the stalks 40S into the throat to allow the knock-down roller 50 to bend the stalks 40S downwardly in conjunction with the action of the fin roller 52. Once the stalks 40S are angled downward as shown in FIG. 1, the base cutter assembly 56 may then sever the base of the stalks 40S from field 28. The severed stalks 40S are then, by the movement of the vehicle 10, directed to the feed roller assembly 58.

The severed sugarcane stalks 40S are conveyed rearwardly by the bottom and top rollers 60, 62, which compresses the stalks 40S, makes them more uniform and shakes loose debris 68 to pass through the bottom rollers 60 to the field 28. At the downstream end portion of the feed roller assembly 58, the chopper assembly 64 cuts or chops the compressed sugarcane stalks 40S into pieces or billets 40B (e.g., 6-inch cane sections). The processed crop discharged from the chopper assembly 64 is then directed as a stream of billets 40B and debris 68 into the primary extractor 70. The airborne debris 68 (e.g., dust, dirt, leaves, etc.) separated from the billets 40B is then extracted through the primary extractor 70 using suction created by the extractor fan 72. The separated/cleaned billets 40B then be directed to an elevator hopper into the elevator assembly 66 and travel upwardly via the elevator 78 from its proximal end portion 80 to its distal end portion 82. During normal operation, once the billets 40B reach the distal end portion 82 of the elevator 78, the billets 40B fall through the elevator discharge opening 98 to an external storage device. If provided, the secondary extractor 94 (with the aid of the extractor fan 96) blows out trash/debris 68 from the vehicle 10, similar to the primary extractor 70.

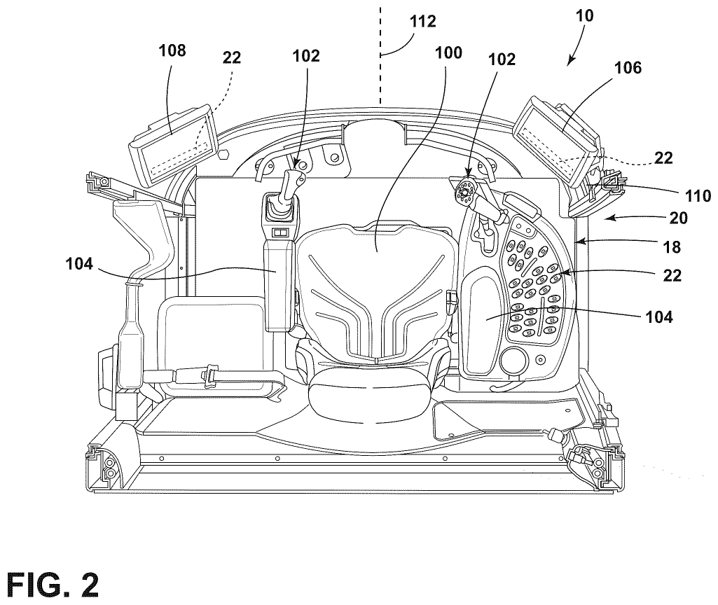

Referring to FIG. 2, an interior of the cab 18 of the vehicle 10 may include a seat 100, on which the operator sits when operating the vehicle 10. In various embodiments, steering/operating controls 102 can be located near the seat 100, so as to be within arm's reach of the operator when the operator is seated. Though a pair of joysticks is illustrated in the example of FIG. 2, other embodiments of the vehicle 10 may include other devices for receiving steering inputs from the operator. For example, in place of one or more joysticks, the cab 18 may have a steering wheel, left/right control bars, a hand controller, pedals, or another suitable device for receiving steering inputs. Also located near the seat 100, at the operator's feet, can be one or more pedals. The pedals may be configured to receive input from the operator for controlling the speed of the vehicle 10. Further, in embodiments in which the vehicle 10 is semi-autonomous or fully autonomous, the steering controls 102 and/or the pedals may be omitted. An armrest 104 may be positioned along one or both sides of the seat 100. in some instances, the armrest 104 may include one or more input devices 22.

As illustrated, the HMI 20 may include a first display 106 positioned at least partially on a first side of a vehicle centerline 112 and a second display 108 positioned at least partially on a second, opposing side of the vehicle centerline 112. Each of the first display 106 and the second display 108 may be operably coupled to the cab 18 through a support structure 110. Each of the first display 106 and the second display 108 may be configured to provide information to the operator, such as vehicle information (e.g., ground speed, oil pressure, engine temperature, etc.), operational information that may impact harvesting performance (e.g., elevator position, agricultural product flow rate, external storage device position, etc.), and manufacturer proprietary systems information (e.g. Advanced Farming Systems (AFS) information, including yield maps, position data, etc.).

In some instances, one of the first display 106 and the second display 108 may provide a first set of information related to operational information while the other one or the first display 106 and second display 108 may provide a second set of information related to vehicle information. In some cases, the first display 106 may provide the first set of information when the elevator discharge opening 98 is positioned on a first common side of the vehicle centerline 112. Conversely, the second display 108 may provide the first set of information when the elevator discharge opening 98 is positioned on a second common side of the vehicle centerline 112.

In various examples, the first display 106 and/or the second display 108 may be configured as any practicable type of graphic-producing device or part of a device that presents graphics in visual form. Moreover, in some examples, the first display 106 and/or the second display 108 may be configured as a heads-up display (HUD). The HUD may display a heads-up image on a window, or any other surface, of the cab 18. The HUD allows a transparent or semi-transparent display to present data without the user looking away from their typical viewpoints. The HUD may contain a projector unit, a combiner, and a display generation device. The HUD may include a convex lens or a concave mirror with an LED/LCD at its focus.

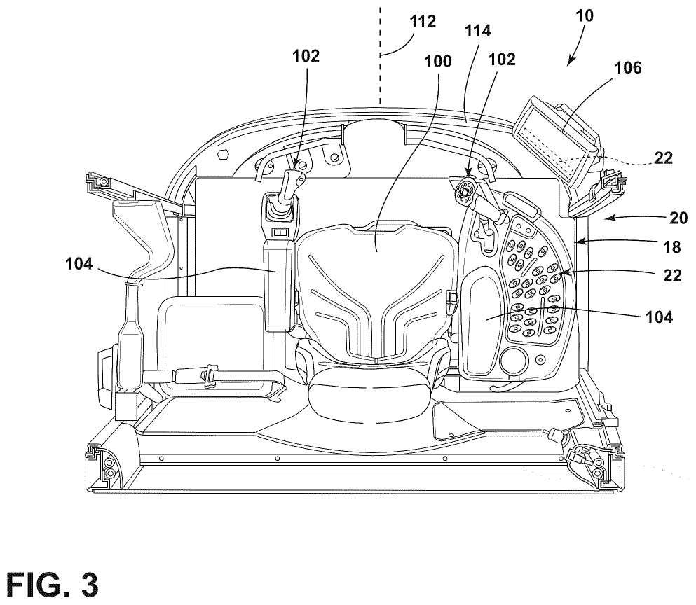

Referring to FIG. 3, in some instances, rather than having first and second displays 106, 108, the HMI 20 may allow for a single display to be actuated or slid from one side of the vehicle centerline 112 to the opposite side of the vehicle centerline 112 based on the location of the elevator discharge opening 98. In such instances, the cab 18 can include a guide assembly 114 for moving the display between the first and second positions. In some cases, the first position may place the first display 106 at least partially on a first side of the vehicle centerline 112 and the second position may place the first display 106 at least partially on a second side of the vehicle centerline 112. Based on the position for which the display is placed in may dictate the information that is provided on the display. Moreover, in some instances, instructions to move the display from one position to the other may be provided on the first display 106 if the first display 106 is on an opposed side of the vehicle centerline 112 from the elevator discharge opening 98.

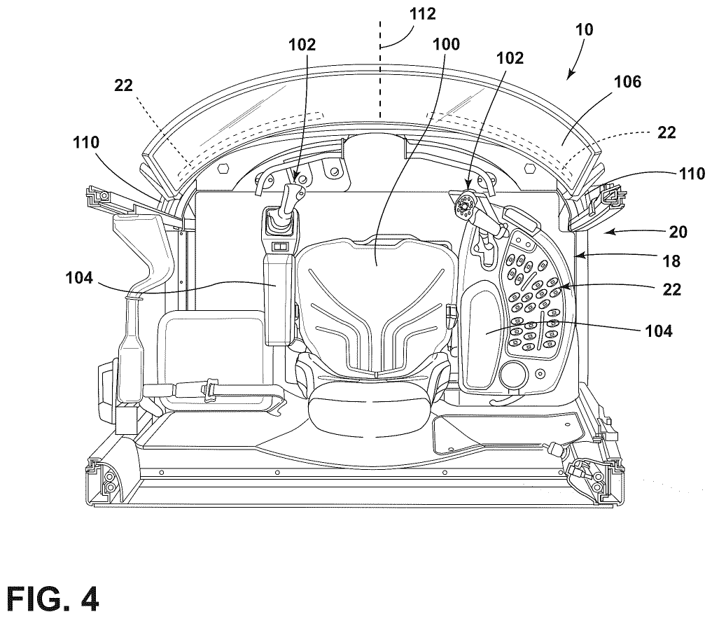

Referring to FIG. 4, in some cases, rather than having first and second displays 106, 108, the HMI 20 may allow for a single display that extends from a first side of the vehicle centerline 112 to a second side of the vehicle centerline 112. In such instances, the information provided on various segments of the display may be altered based on the location of the elevator discharge opening 98. For instance, a first segment of the display may be oriented on a first side of the vehicle centerline 112 and a second segment may be oriented on a second, opposing side of the vehicle centerline 112. In some cases, the first segment may provide the first set of information when the elevator discharge opening 98 is positioned on a first common side of the vehicle centerline 112. Conversely, the second segment may provide the first set of information when the elevator discharge opening 98 is positioned on a second common side of the vehicle centerline 112.

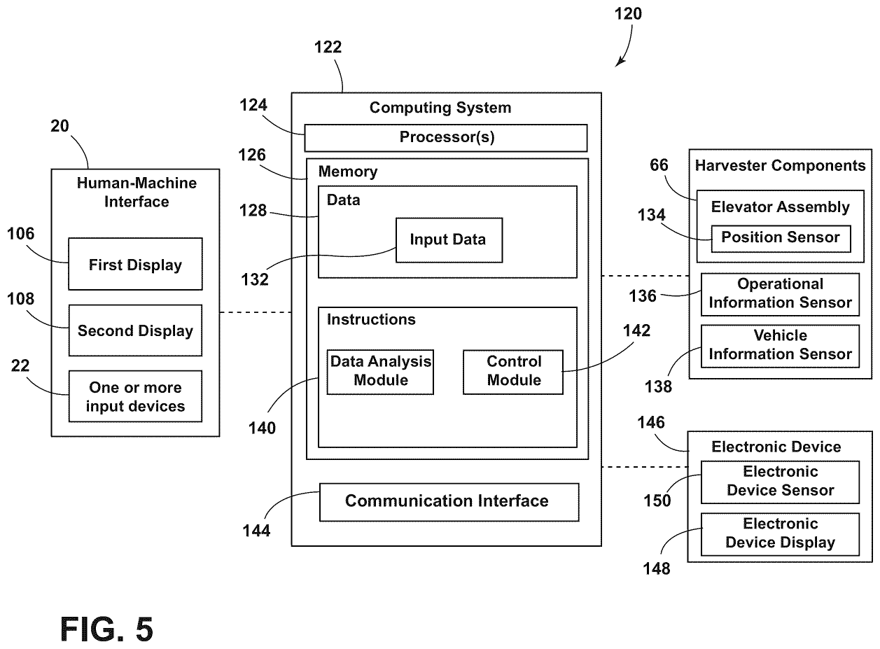

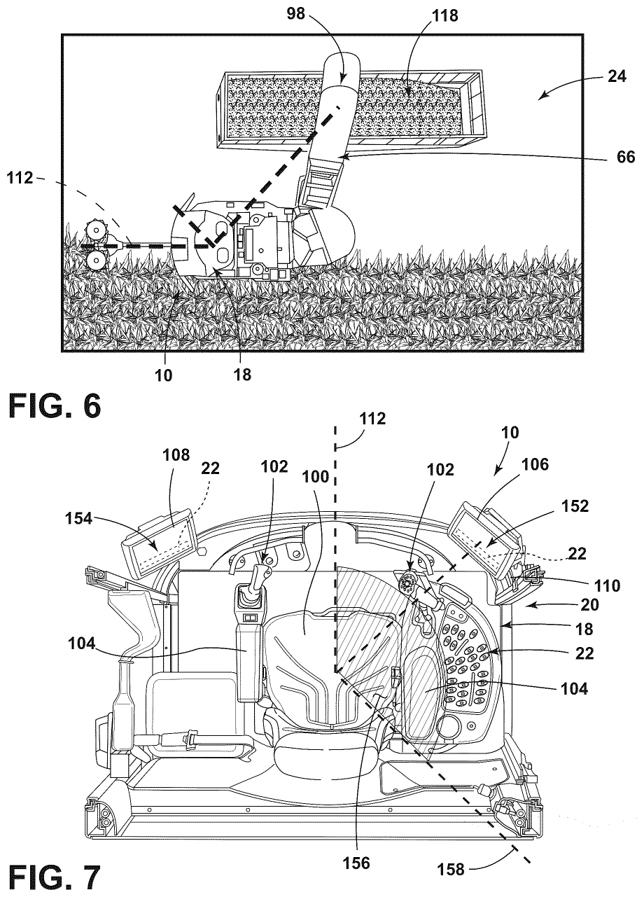

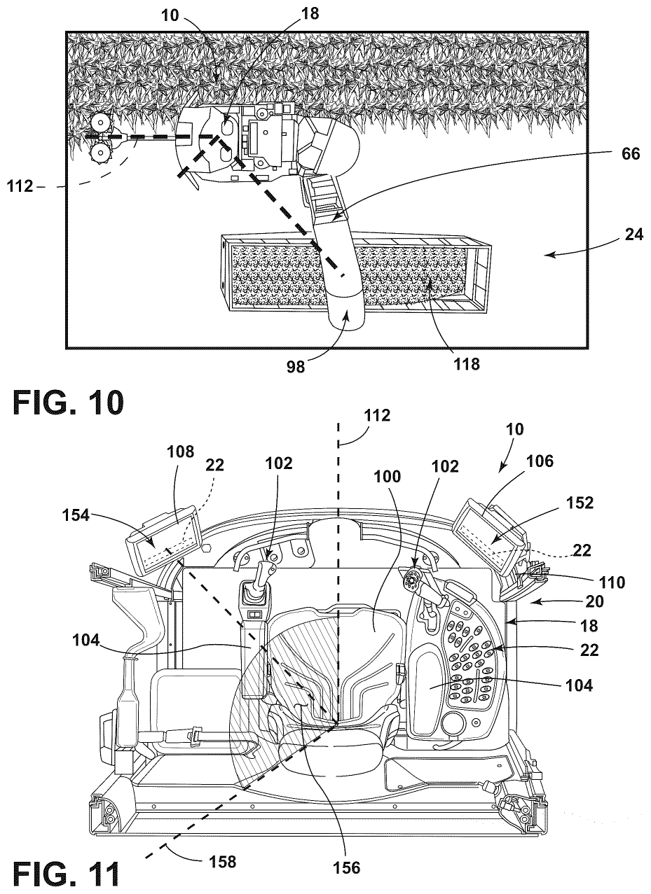

Referring now to FIGS. 5-13, during a harvesting operation, the separated/cleaned billets 40B (FIG. 1) can be directed to an elevator hopper and travel upwardly via the elevator 78 (FIG. 1). The billets 40B (FIG. 1) may then fall through the elevator discharge opening 98 to an external storage device 118. In some cases, as illustrated in FIG. 6, the external storage device 118 may be positioned on a first side of the vehicle centerline 112 when the to-be-processed portion of the field 28 is generally positioned on a second, opposing side of the vehicle centerline 112. Likewise, as illustrated in FIG. 10, the external storage device 118 may be positioned on the second side of the vehicle centerline 112 when the to-be-processed portion of the field 28 is generally positioned on the first, opposing side of the vehicle centerline 112. In some cases, the HMI 20 can include a pair of displays and the information provided on each display may be altered based on various vehicle conditions, such as a position of the elevator discharge opening 98 relative to a vehicle centerline 112. In various examples, the system 100 may be configured to determine the number of displays 106, 108 that are in use to determine how to display the operational information and/or the vehicle information. Additionally or alternatively, an operator can select between having two different displays, 106, 108, turn one of the displays 106, 108 off, display at least some of the same information on two displays 106, 108, and/or remove/add a display 106, 108 at any time during the lifespan of the vehicle 10 (e.g., such as a secondary standalone display).

Referring to FIG. 5, a schematic view of a system 120 for operating the work vehicle 10 is illustrated in accordance with aspects of the present subject matter. In general, the system 120 will be described with reference to the work vehicle 10 described above with reference to FIGS. 1-4. However, it should be appreciated by those of ordinary skill in the art that the disclosed system 120 may generally be utilized with agricultural vehicles having any other suitable machine configuration. Additionally, it should be appreciated that, for purposes of illustration, communicative links, or electrical couplings of the system 120 shown in FIG. 5 are indicated by dashed lines.

In several embodiments, the system 120 may include the computing system 122 and various other components configured to be communicatively coupled to and/or controlled by the computing system 122. In some embodiments, the computing system 122 is physically coupled to the vehicle 10. In other embodiments, the computing system 122 is not physically coupled to the vehicle 10 and instead may communicate with the vehicle 10 over a network.

As illustrated, the HMI 20 may be operably coupled with the computing system 122. As provided herein, the HMI 20 can include a first display 106 and/or a second display 108 that may each be capable of displaying information related to the operation of the vehicle 10 and/or systems or components operably coupled with the vehicle 10. In some examples, the first display 106 and/or the second display 108 may each include an input device 22 in the form of circuitry within a touchscreen to receive an input corresponding with a location over the respective display 106, 108. Additionally, the HMI 20 may also include various other types or forms of input devices 22, such as one or more joysticks, buttons, knobs, levers, input pads, and/or any other practicable device.

It will be appreciated that, in addition to the HMI 20 being considered an input device that allows an operator to provide inputs to the computing system 122, the HMI 20 may also function as an output device. For instance, the HMI 20 may be configured to allow the computing system 122 to provide feedback to the operator (e.g., visual feedback via a display 106, 108 or other presentation device, audio feedback via a speaker or other audio output device, and/or the like).

In general, the computing system 122 may correspond to any suitable processor-based device(s), such as a computing device or any combination of computing devices. Thus, as shown in FIG. 5, the computing system 122 may generally include one or more processor(s) 124 and associated memory devices 126 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 126 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 126 may generally be configured to store information accessible to the processor(s) 124, including data 128 that can be retrieved, manipulated, created, and/or stored by the processor(s) 124 and instructions 130 that can be executed by the processor(s) 124.

In several embodiments, the data 128 may be stored in one or more databases. For example, the memory 126 may include an input database 132 for storing input data received from the HMI 20, a position sensor configured to detect a position of the elevator discharge opening 98 (FIG. 1) relative to the vehicle centerline 112 (FIG. 6), an operational information sensor 136 operably coupled with one or more vehicle components, and/or a vehicle information sensor 138 operably coupled with one or more vehicle components. The data 128 stored within the input database 132 may be used for subsequent processing and/or analysis.

Referring still to FIG. 5, in several embodiments, the instructions 130 stored within the memory 126 of the computing system 122 may be executed by the processor(s) 124 to implement a data analysis module 140. In general, the data analysis module 140 may be configured to analyze the input data (e.g., a set of input data received at a given time or within a given period or a subset of the data, which may be determined through a pre-processing method) to determine a position of the elevator discharge opening 98 (FIG. 1). Based on the determined position of the elevator discharge opening 98 (FIG. 1), a control module 142 stored within the memory may provide instructions for the HMI 20 to provide various forms of information on each display.

Moreover, as shown in FIG. 5, the computing system 122 may also include a communications interface 144 to communicate with any of the various other system components described herein. For instance, one or more communicative links or interfaces (e.g., one or more data buses and/or wireless connections) may be provided between the communications interface 144 and the HMI 20 to allow data transmitted from the HMI 20 to be received by the computing system 122. Additionally, as shown in FIG. 5, one or more communicative links or interfaces (e.g., one or more data buses and/or wireless connections) may be provided between the communications interface 144 and one or more harvester components of the vehicle 10 (FIG. 1) to allow the computing system 122 to control the operation of such components and/or to receive data associated with various components from one or more of a position sensor 134 configured to detect a position of the elevator discharge opening 98 (FIG. 1), an operational information sensor 136 operably coupled with one or more vehicle components, and/or a vehicle information sensor 138 operably coupled with one or more vehicle components.

Further, the computing system 122 may communicate via wired and/or wireless communication with one or more remote electronic devices 146 through a communications interface 144. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 146 may also include a display 148 for displaying information to a user. For instance, the electronic device 146 may be configured to form the first display 106 or the second display 108 based on the position of the electronic device within the vehicle 10 (FIG. 1), which may be defined by an operator of the electronic device and/or through one or more location sensors 150 integrated within the electronic device (and/or the vehicle 10 (FIG. 1)). In addition, the electronic device 146 may provide feedback information, such as visual, audible, and tactile alerts, and/or allow the user to alter or adjust one or more harvester components of the vehicle 10 (FIG. 1) through the usage of the remote electronic device 146. It will be appreciated that the electronic device 146 may be any one of a variety of computing devices and may include a processor and memory. For example, the electronic device 146 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

In operation, based on the position of the elevator discharge opening 98 (FIG. 1) defined by the elevator assembly 66 relative to the vehicle centerline 112 (FIG. 6), the information to be illustrated on each display may be defined. For instance, one of the first display 106 and the second display 108 may provide a first set 152 of information related to operational information while the other one or the first display 106 and second display 108 may provide a second set 154 of information related to vehicle information.

In various examples, the position of the elevator discharge opening 98 (FIG. 1) may be determined through one or more inputs or methods. For example, the position of the elevator discharge opening 98 (FIG. 1) may be determined based on one or more received inputs through the one or more input devices 22, which may be positioned within the cab 18 and/or remote from the cab 18. Additionally or alternatively, one or more position sensors 134 may be operably coupled with the elevator assembly 66 and configured to provide data indicative of a location of the elevator discharge opening 98 (FIG. 1). In such instances, the one or more position sensors 134 may correspond to an imaging sensor (an area-type image sensor, such as a CCD or a CMOS image sensor, and image-capturing optics that capture an image of an imaging field of view), a light detection and ranging (LIDAR) sensor, a radio detection and ranging (RADAR) sensor, a Hall effect sensor, a gyroscope sensor, a magnetometer sensor, an accelerometer sensor, a yaw-rate sensor, a piezoelectric sensor, a position sensor 134, a complementary metal-oxide-semiconductor (CMOS) sensor, a pressure sensor, a capacitive sensor, an ultrasonic sensor, or any other suitable type of sensor.

As illustrated in FIGS. 6-9, the external storage device 118 may be positioned on a first side of the vehicle centerline 112 when the to-be-processed portion of the field 28 is generally positioned on a second, opposing side of the vehicle centerline 112. In such instances, the first display 106 may provide a first set 152 of information related to operational information while the second display 108 may provide a second set 154 of information related to vehicle information. In such instances, the operational information, which may be viewed more frequently by the operator, may be positioned on a common side of the vehicle centerline 112 as the elevator discharge opening 98 while vehicle information, which may be viewed less frequently by the operator may be positioned on an opposite side of the vehicle centerline 112 from the elevator discharge opening 98. As such, a focus region 156 that includes a line of sight 158 to the elevator discharge opening 98, the operational information, and the vehicle centerline 112 may also be located on a common side of the vehicle centerline 112 as the elevator discharge opening 98.

As illustrated in FIGS. 10-13, the external storage device 118 may be positioned on the second side of the vehicle centerline 112 when the to-be-processed portion of the field 28 is generally positioned on the first, opposing side of the vehicle centerline 112. In such instances, the second display 108 may provide a first set 152 of information related to operational information while the first display 106 may provide a second set 154 of information related to vehicle information. In such instances, the operational information, which may be viewed more frequently by the operator may be positioned on a common side of the vehicle centerline 112 as the elevator discharge opening 98 while vehicle information, which may be viewed less frequently by the operator may be positioned on an opposite side of the vehicle centerline 112 from the elevator discharge opening 98. As such, a focus region 156 that includes a line of sight 158 to the elevator discharge opening 98, the operational information, and the vehicle centerline 112 may also be located on a common side of the vehicle centerline 112 as the elevator discharge opening 98.

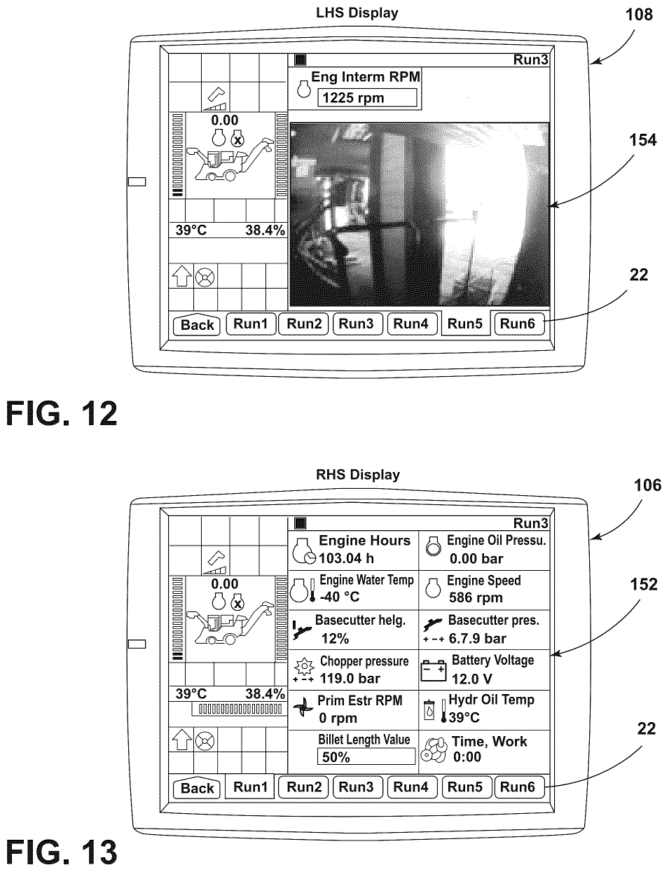

As illustrated in FIGS. 9 and 12, the first set 152 of information may be related to the operational information of the vehicle 10. In some cases, the operational information can be related to an elevator position, an agricultural product flow rate, an external storage device 118 position, and so on. In various examples, such information may be determined based on data provided from one or more operational information sensors 136. The operational information sensors 136 may correspond to an imaging sensor (an area-type image sensor, such as a CCD or a CMOS image sensor, and image-capturing optics that capture an image of an imaging field of view), a light detection and ranging (LIDAR) sensor, a radio detection and ranging (RADAR) sensor, a Hall effect sensor, a gyroscope sensor, a magnetometer sensor, an accelerometer sensor, a yaw-rate sensor, a piezoelectric sensor, a position sensor 134, a complementary metal-oxide-semiconductor (CMOS) sensor, a pressure sensor, a capacitive sensor, an ultrasonic sensor, or any other suitable type of sensor. As such, in some instances, the first set 152 of information can include image data of at least a portion of the elevator assembly 66.

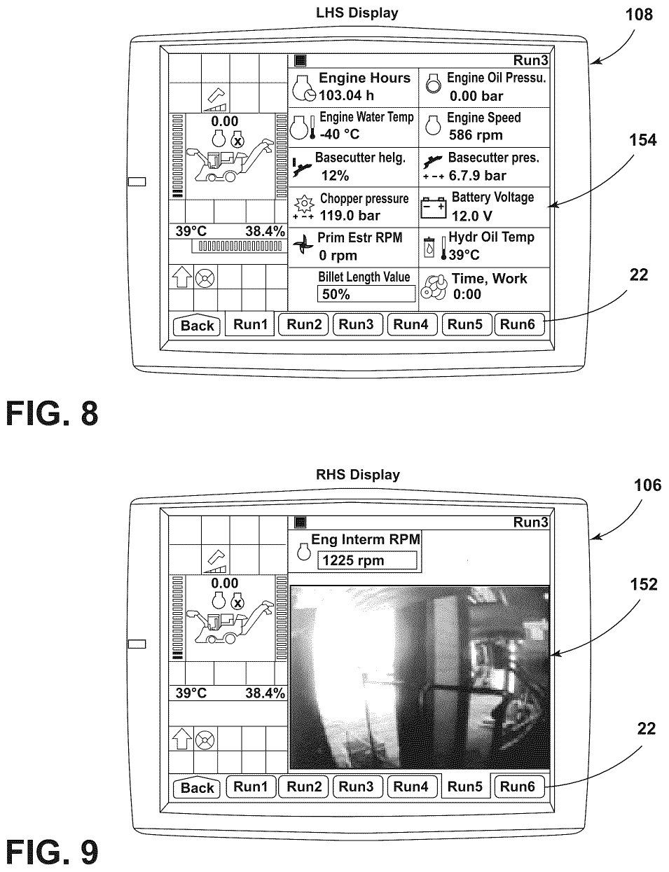

As illustrated in FIGS. 8 and 13, the second set 154 of information may be related to the vehicle information of the vehicle 10. In some cases, the vehicle information can be related to ground speed, oil pressure, engine temperature, manufacturer proprietary systems information (e.g. Advanced Farming Systems (AFS) information, including yield maps, position data, etc.), and so on. In various examples, such information may be determined based on data provided from one or more vehicle information sensors 138. The vehicle information sensors 138 may correspond to an imaging sensor (an area-type image sensor, such as a CCD or a CMOS image sensor, and image-capturing optics that capture an image of an imaging field of view), a light detection and ranging (LIDAR) sensor, a radio detection and ranging (RADAR) sensor, a Hall effect sensor, a gyroscope sensor, a magnetometer sensor, an accelerometer sensor, a yaw-rate sensor, a piezoelectric sensor, a position sensor 134, a complementary metal-oxide-semiconductor (CMOS) sensor, a pressure sensor, a capacitive sensor, an ultrasonic sensor, or any other suitable type of sensor. In some instances at least one of the operational information sensor 136, the vehicle information sensor 138, and/or the position sensor 134 may be configured as a common sensor with one of the remaining sensors without departing from the scope of the present disclosure.

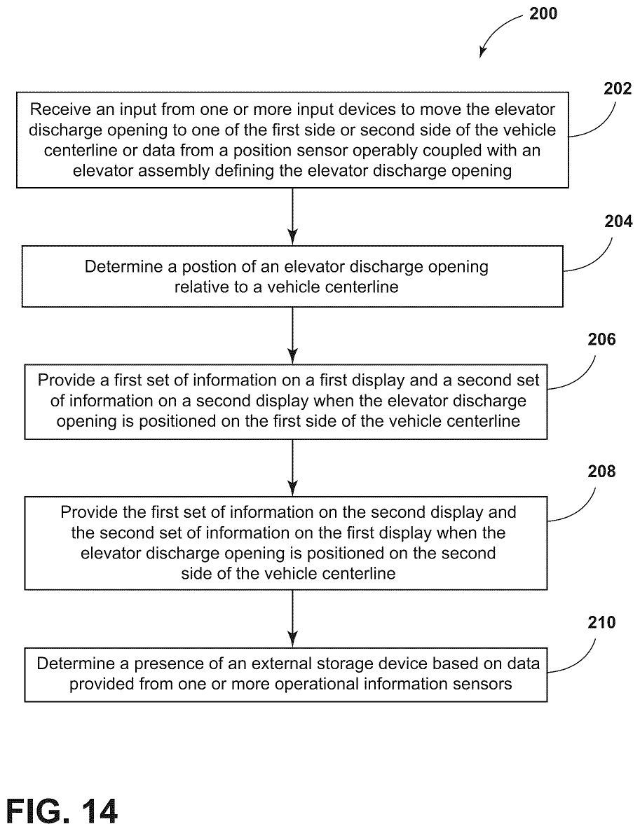

Referring now to FIG. 14, a method 200 for operating a vehicle is illustrated in accordance with aspects of the present subject matter. In general, the method 200 will be described herein with reference to the vehicle 10 described above with reference to FIGS. 1-13. However, the disclosed method 200 may generally be utilized with any suitable cutting and harvesting assembly. In addition, although FIG. 14 depicts steps performed in a particular order for purposes of illustration and discussion, the methods discussed herein are not limited to any particular order or arrangement. One skilled in the art, using the disclosure provided herein, will appreciate that various steps of the methods disclosed herein can be omitted, rearranged, combined, and/or adapted in various ways without deviating from the scope of the present disclosure.

As shown in FIG. 14, at (202), the method 200 can include receiving an input from one or more input devices to move the elevator discharge opening to one of the first side or the second side of the vehicle centerline or data from a position sensor operably coupled with an elevator assembly defining the elevator discharge opening.

At (204), the method 200 can include determining a position of an elevator discharge opening relative to a vehicle centerline. For example, the position of the elevator discharge opening may be determined based on one or more received inputs through the one or more input devices, which may be positioned within the cab and/or remote from the cab. Additionally or alternatively, one or more position sensors may be operably coupled with the elevator assembly and configured to provide data indicative of a location of the elevator discharge opening.

At (206), the method 200 can include providing a first set of information on a first display positioned at least partially on a first side of the vehicle centerline and a second set of information on a second display positioned at least partially on a second side of the vehicle centerline when the elevator discharge opening is positioned on the first side of the vehicle centerline. Alternatively, rather than having first and second displays, the HMI may allow for a single display that extends from a first side of the vehicle centerline to a second side of the vehicle centerline. Alternatively, rather than having first and second displays, the HMI may allow for a single display to be actuated or slid from one side of the vehicle centerline to the opposite side of the vehicle centerline based on the location of the elevator discharge opening.

As provided herein, in various examples, the system may determine the number of displays that are in use to determine how to display the operational information and/or the vehicle information. Additionally or alternatively, an operator can select between having two different displays, turn one of the displays off, display at least some of the same information on two displays, and/or remove/add a display 106, 108 at any time during the lifespan of the vehicle 10 (e.g., such as a secondary standalone display).

At (208), the method 200 can include providing the first set of information on the second display and the second set of information on the first display when the elevator discharge opening is positioned on the second side of the vehicle centerline.

In some cases, the first set of information includes operational information related to at least one of an elevator position, an agricultural product flow rate, or an external storage device position. In addition, in various cases, the second set of information includes vehicle information related to at least one of a ground speed, an oil pressure, or an engine temperature of the vehicle.

At (210), the method 200 can include determining a presence of an external storage device based on data provided from one or more operational information sensors.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural harvester, the system comprising:
an elevator assembly defining an elevator discharge opening;
a first display positioned at least partially on a first side of a vehicle centerline of the agricultural vehicle;
a second display positioned at least partially on a second side of a vehicle centerline of the agricultural vehicle; and
a computing system communicatively coupled to the first display and the second display, the computing system being configured to:
determine a position of the elevator discharge opening relative to the vehicle centerline;
display a first set of information on the first display when the elevator discharge opening is positioned on the first side of the vehicle centerline; and
display the first set of information on the second display when the elevator discharge opening is positioned on the second side of the vehicle centerline.

2. The system of claim 1, wherein the first set of information includes operational information related to at least one of an elevator position, an agricultural product flow rate, or an external storage device position.

3. The system of claim 1, wherein the computing system is further configured to:
display a second set of information on the second display when the elevator discharge opening is positioned on the first side of the vehicle centerline.

4. The system of claim 3, wherein the second set of information includes vehicle information related to at least one of a ground speed, an oil pressure, or an engine temperature of the vehicle.

5. The system of claim 1, wherein the computing system is further configured to:
display a second set of information on the second display when the elevator discharge opening is positioned on the first side of the vehicle centerline.

6. The system of claim 5, wherein the second set of information includes vehicle information related to at least one of a ground speed, an oil pressure, or an engine temperature of the vehicle.

7. The system of claim 1, wherein the position of the elevator discharge opening relative to the vehicle centerline is determined based on a received input from an input device.

8. The system of claim 1, wherein the position of the elevator discharge opening relative to the vehicle centerline is determined based on data provided from a position sensor.

9. The system of claim 1, wherein the first set of information includes image data of at least a portion of the elevator assembly.

10. A method for operating an agricultural vehicle, the method comprising:
determining a position of an elevator discharge opening relative to a vehicle centerline;
providing a first set of information on a first display positioned at least partially on a first side of the vehicle centerline and a second set of information on a second display positioned at least partially on a second side of the vehicle centerline when the elevator discharge opening is positioned on the first side of the vehicle centerline; and
providing the first set of information on the second display and the second set of information on the first display when the elevator discharge opening is positioned on the second side of the vehicle centerline.

11. The method of claim 10, further comprising:
receiving an input from one or more input devices to move the elevator discharge opening to one of the first side or the second side of the vehicle centerline, wherein determining the position of the elevator discharge opening relative to the vehicle centerline is based on the input.

12. The method of claim 10, further comprising:
receiving data from a position sensor operably coupled with an elevator assembly defining the elevator discharge opening, wherein determining the position of the elevator discharge opening relative to the vehicle centerline is based on the data received from the position sensor.

13. The method of claim 10, wherein the first set of information includes operational information related to at least one of an elevator position, an agricultural product flow rate, or an external storage device position.

14. The method of claim 10, wherein the second set of information includes vehicle information related to at least one of a ground speed, an oil pressure, or an engine temperature of the vehicle.

15. The method of claim 10, further comprising:
determining a presence of an external storage device based on data provided from one or more operational information sensors.

16. A system for an agricultural vehicle, the system comprising:
an elevator assembly defining an elevator discharge opening;
a first display positioned at least partially on a first side of a vehicle centerline of the agricultural vehicle; and
a computing system communicatively coupled to the first display, the computing system being configured to:
determine a position of the elevator discharge opening relative to the vehicle centerline;
provide a first set of information on the first side of the vehicle centerline when the elevator discharge opening is positioned on the first side of the vehicle centerline; and
provide the first set of information on the second side of the vehicle centerline when the elevator discharge opening is positioned on a second side of the vehicle centerline.

17. The system of claim 16, further comprising:
a second display positioned at least partially on a second side of a vehicle centerline of the agricultural vehicle, wherein the first set of information provided on the first side of the vehicle centerline is displayed on the first display and the first set of information provided on the second side of the vehicle centerline is displayed on the second display.

18. The system of claim 16, further comprising:
a track assembly operably coupled with the first display, wherein the first display is positioned on the first side of the vehicle centerline along the track assembly when the elevator discharge opening is positioned on the first side of the vehicle centerline and the first display is positioned on the second side of the vehicle centerline along the track assembly when the elevator discharge opening is positioned on the second side of the vehicle centerline.

19. The system of claim 16, wherein the position of the elevator discharge opening relative to the vehicle centerline is determined based on a received input from an input device.

20. The system of claim 16, wherein the position of the elevator discharge opening relative to the vehicle centerline is determined based on data provided from a position sensor.
